(19) United States
(12) Patent Application Publication
(10) Pub. No.: US 2016/0129483 A1
(43) Pub. Date: May 12, 2016

(54) Pressure-Sensing Rollers For Lamination Systems

(71) Applicant: Apple Inc., Cupertino, CA (US)

(72) Inventors: Kuo-Hua Sung, San Jose, CA (US); Dong Cheol Jung, Gumi-si (KR); Hak Soo Jeong, Gumi-si (KR); Do Lyun Kim, Gumi City, Kyung sang buk do (KR)

(21) Appl. No.: 14/897,095

(22) PCT Filed: Jun. 18, 2013
(86) PCT No.: PCT/US2013/046303

§ 371 Date: Dec. 9, 2015

(51) Int. Cl. B08B 7/00; B08B 1/00

(52) U.S. Cl. CPC B08B 7/0028; B08B 1/001

(57) ABSTRACT

An assembly system may be provided for attaching together display layers for an electronic device display. The system may include substrate cleaning equipment that includes one or more pressure-sensing cleaning rollers (124) for removing debris from the display layers during assembly operations. A pressure-sensing cleaning roller (124) may include a cylindrical roller member having a tacky surface and one or more pressure sensors (136) configured to sense pressures that are applied to the display layers during cleaning operations. The position and orientation of the cleaning rollers (124) may be adjusted before or during cleaning operations based on pressure data gathered using the pressure sensors. The pressure sensors (136) may be attached to the tacky surface of the cylindrical roller member, attached to an edge of the roller member, embedded within the roller member, or attached to other equipment that moves with the roller member.

### BACKGROUND

This relates generally to assembly systems, and more particularly, to assembly systems for electronic devices with displays.

Electronic devices such as portable computers and cellular telephones are often provided with displays. Displays are formed from multiple display layers such as a cover glass layer for protecting the display and internal components, a touch screen panel for gathering touch input from a user, and a stack of liquid crystal display (LCD) structures that generate display images. The display layers are commonly laminated together using adhesive.

Prior to lamination, display substrates are passed through a cleaning system to remove debris from the substrates. Cleaning systems of this type often include cleaning rollers that roll across the surface of a substrate and collect debris from the substrate.

If care is not taken, excess pressure from a cleaning roller can damage sensitive display components during cleaning operations. Damage of this type can cause display substrates to have to be repaired or discarded, undesirably increasing costs and reducing the efficiency of display assembly operations.

It would therefore be desirable to be able to provide improved assembly systems for electronic devices with displays.

### SUMMARY

An assembly system may be provided for assembling electronic device displays. The assembly system may include lamination equipment for laminating structures together and pre-processing equipment such as cleaning equipment for removing protective films and/or removing debris from the structures prior to lamination.

The structures may be display layers or display substrates for an electronic device display such as a transparent cover layer, a touch-sensitive layer, and a liquid crystal display cell. Adhesive sheets such as sheets of optically clear adhesive can be used to laminate the substrates together. The optically clear adhesive may be an optically clear ultraviolet-light-curable adhesive.

The pre-processing equipment may include cleaning rollers that remove debris from the structures prior to lamination. A structure such as a display substrate may be rolled between two or more cleaning rollers during cleaning operations. In order to minimize potential damage to sensitive electronic components on the substrate during cleaning operations, one or more of the cleaning rollers may be provided with pressure sensors that monitor the pressure with which the rollers are pressed against the substrate. Pressure sensors may be mounted to a cleaning roller, embedded within a cleaning roller or mounted to actuating equipment for the cleaning rollers.

Actuating equipment such as computer-controlled positioning equipment that is coupled to the rollers may actively adjust the position and tilt of the cleaning rollers based on pressure data that is continuously gathered from the pressure sensors during cleaning operations.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with a display in accordance with an embodiment of the present invention.

FIG. 2 is a cross-sectional side view of an illustrative display in accordance with an embodiment of the present invention.

FIG. 3 is a cross-sectional side view of illustrative display layers and backlight structures in accordance with an embodiment of the present invention.

FIG. 4 is a diagram of an illustrative assembly system having lamination equipment and pre-processing equipment in accordance with an embodiment of the present invention.

FIG. 5 is a diagram of illustrative pre-processing equipment of an assembly system of the type shown in FIG. 4 in accordance with an embodiment of the present invention.

FIG. 6 is a diagram of illustrative pre-processing equipment showing how a substrate may pass between cleaning rollers having pressure sensors in accordance with an embodiment of the present invention.

FIG. 7 is a diagram of illustrative pre-processing equipment showing how the position and orientation of a cleaning roller having pressure sensors may be adjusted in accordance with an embodiment of the present invention.

FIG. 8 is a perspective view of an illustrative pressure-sensing cleaning roller in accordance with an embodiment of the present invention.

FIG. 9 is a diagram of illustrative pre-processing equipment having multiple cleaning rollers and a transfer roller on each side of a substrate to be cleaned in accordance with an embodiment of the present invention.

FIG. 10 is a diagram of illustrative pre-processing equipment showing how pressure sensors for cleaning rollers may be mounted to actuating equipment for the cleaning rollers in accordance with an embodiment of the present invention.

FIG. 11 is a flow chart of illustrative steps involved in cleaning display substrates using pressure-sensing cleaning rollers in accordance with an embodiment of the present invention.

### DETAILED DESCRIPTION

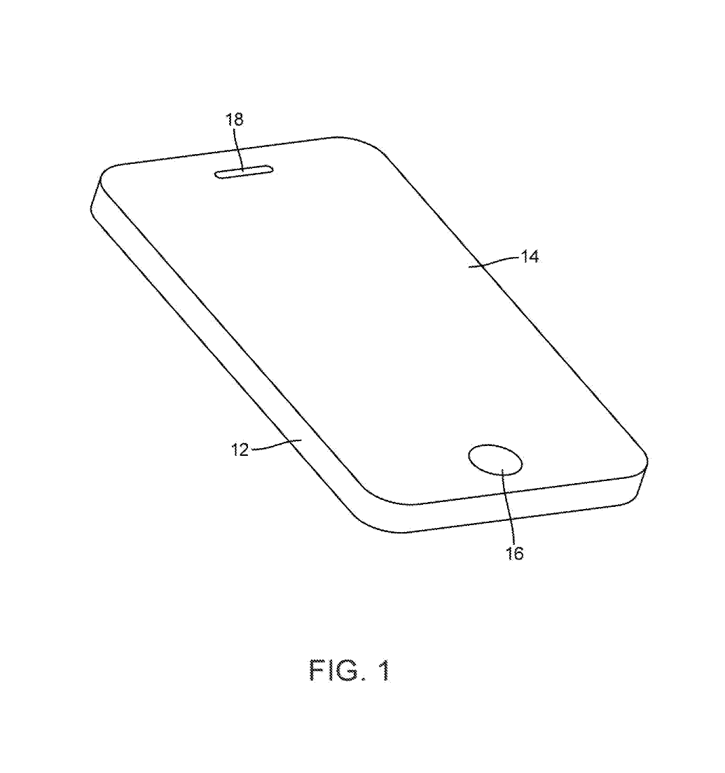

Electronic devices may include displays. The displays may be used to display images to a user. An illustrative electronic device that may be provided with a display is shown in FIG. 1.

As shown in FIG. 1, electronic device 10 may be a handheld device such as a cellular telephone, music player, gaming device, navigation unit, or other compact device. In this type of configuration for device 10, housing 12 may have opposing front and rear surfaces. Display 14 may be mounted on a front face of housing 12. Display 14 may, if desired, have a display cover layer or other exterior layer that includes openings for components such as button 16. Openings may also be formed in a display cover layer or other display layer to accommodate a speaker port such as port 18.

The illustrative configuration for device 10 of FIG. 1 is merely illustrative. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Display 14 may be a touch-sensitive display that includes a touch sensor layer or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components formed on a touch-sensor substrate.

Displays for device 10 may, in general, include image pixels formed from light-emitting diodes (LEDs), organic LEDs (OLEDs), plasma cells, electrowetting pixels, electrophoretic pixels, liquid crystal display (LCD) components, or other suitable image pixel structures. In some situations, it may be desirable to use LCD components to form display 14, so configurations for display 14 in which display 14 is a liquid crystal display are sometimes described herein as an example. It may also be desirable to provide displays such as display 14 with backlight structures, so configurations for display 14 that include a backlight unit may sometimes be described herein as an example. Other types of display technology may be used in device 10 if desired. The use of liquid crystal display structures and backlight structures in device 10 is merely illustrative.

A display cover layer may cover the surface of display 14 or a display layer such as a color filter layer or other portion of a display may be used as the outermost (or nearly outermost) layer in display 14. A display cover layer or other outer display layer may be formed from a transparent glass sheet, a clear plastic layer, or other transparent member.

Touch sensor components such as an array of capacitive touch sensor electrodes formed from transparent materials such as indium tin oxide may be formed on the underside of a display cover layer, may be formed on a separate display layer such as a glass or polymer touch sensor substrate, or may be integrated into other display layers (e.g., substrate layers such as a thin-film transistor layer).

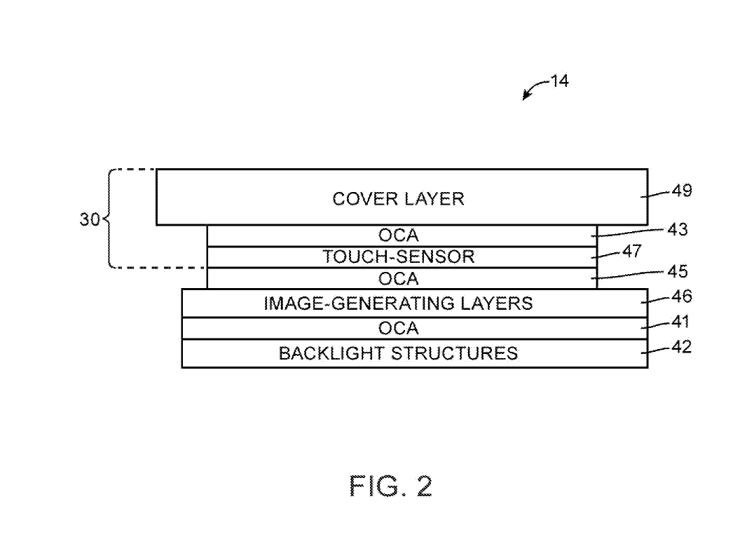

A cross-sectional side view of an illustrative configuration that may be used for display 14 of device 10 is shown in FIG. 2. As shown in FIG. 2, display 14 may include one or more layers of touch-sensitive components such as touch-sensitive layers 47 that are attached to a cover layer such as cover layer 49. Cover layer 49 may be formed from a sheet of rigid or flexible transparent material such as glass or plastic.

Touch-sensitive layers 47 may be attached to cover layer 49 using an adhesive material such as optically clear adhesive (OCA) 43. Optically clear adhesive 43 may be formed from a sheet of compliant light-curable adhesive such as ultraviolet light-curable adhesive, a sheet of pressure-sensitive adhesive or other suitable adhesive material. Touch-sensitive layers 47 may include touch sensor components such as an array of capacitive touch sensor electrodes formed from transparent materials such as indium tin oxide formed on a glass or polymer substrate.

Display 14 may include display layers such as image-generating layers 46 (e.g., a liquid crystal display cell) for generating images to be displayed on display 14. Image-generating layers 46 may include polarizer layers, color filter layers, transistor layers, adhesive layers, layers of liquid crystal material, or other layers for generating display images. Image-generating layers 46 may be attached to touch-sensitive layer 47 using adhesive such as optically clear adhesive 45. Optically clear adhesive 45 may be formed from a sheet of compliant light-curable adhesive such as ultraviolet light-curable adhesive, a sheet of pressure-sensitive adhesive or other suitable adhesive material.

Image-generating layers 46 may use light generated by light-generating structures such as backlight structures 42 to form images to be viewed by a user of device 10. Backlight structures 42 may include light-generating components such as light-emitting diodes, light guiding structures, reflective structures, optical films, etc. Backlight structures 42 may be laminated to image-generating layers 46 using an optically clear adhesive such as optically clear adhesive 41, may be attached to image-generating layers 46 using mechanical attachment members or may be mounted adjacent to layers 46 by attaching backlight structures 42 to one or more structural members in device 10.

During assembly operations for display 14, an assembly system may be used to laminate touch-sensitive layer 47 to cover layer 49 using adhesive layer 43 to form a sensor-on-cover-layer display assembly such as sensor-on-cover-glass (CGS) member 30 (sometimes referred to as a sensor-on-glass assembly, an assembly, or a substrate). The assembly system may then be used to laminate adhesive 45 to touch-sensitive layer 47 prior to laminating image-generating layers 46 to CGS member 30 using adhesive 45.

The assembly system may include pre-processing equipment for removing protective films or removing debris such as dust from one or more display layers such as touch sensitive layer 47, member 30, cover layer 49, or other display substrates. The pre-processing equipment may include pressure-sensing cleaning rollers. Each pressure-sensing cleaning roller may include one or more pressure sensors coupled to a cylindrical roller member having a tacky surface that collects debris as the roller rolls along a surface of a substrate. The pressure sensors may be embedded within a cleaning roller, attached to a cleaning roller, or attached to actuating equipment for the roller. The position and orientation (tilt) of each pressure-sensing cleaning roller may be adjusted prior to cleaning operations or may be continuously adjusted during cleaning operations to avoid applying excess pressure to the substrate.

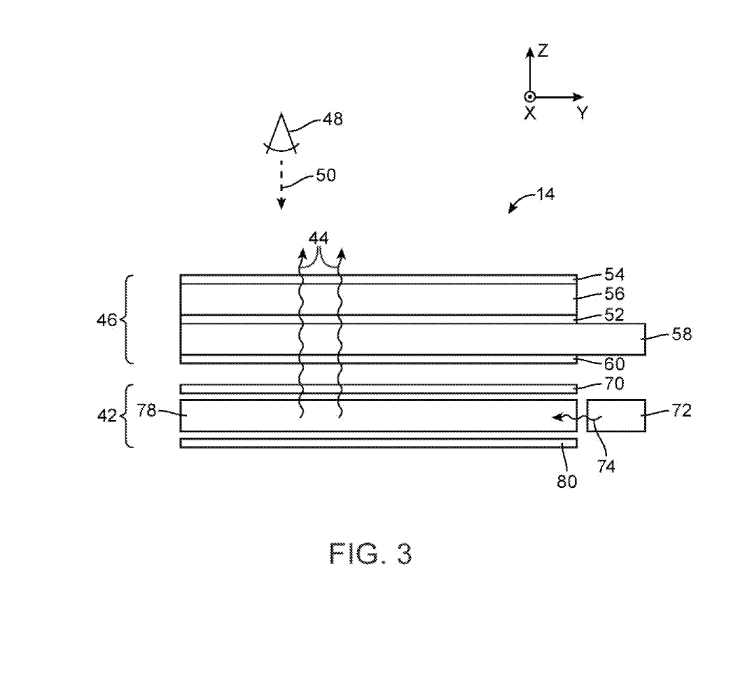

A cross-sectional side view of an illustrative configuration that may be used for image-generating layers 46 and backlight structures 42 of display 14 (e.g., for display layers 46 and backlight structures 42 of the display of FIG. 2, or other suitable display) is shown in FIG. 3. As shown in FIG. 3, display 14 may include backlight structures such as backlight unit 42 for producing backlight 44. During operation, backlight 44 travels outwards (vertically upwards in dimension Z in the orientation of FIG. 3) and passes through display pixel structures in layers 46. This illuminates any images that are being produced by the display pixels for viewing by a user. For example, backlight 44 may illuminate images on image-generating layers 46 that are being viewed by viewer 48 in direction 50.

Image-generating layers 46 may be mounted in chassis structures such as a plastic chassis structure and/or a metal chassis structure to form a display module such as a liquid crystal display cell for attaching to touch-sensitive layer 47. Layers 46 may form a liquid crystal display or may be used in forming displays of other types.

In a configuration in which layers 46 are used in forming a liquid crystal display, layers 46 may include a liquid crystal layer such as liquid crystal layer 52. Liquid crystal layer 52 may be sandwiched between display layers such as layers 58 and 56. Layers 56 and 58 may be interposed between lower polarizer layer 60 and upper polarizer layer 54. If desired, upper polarizer layer 54 may be attached to an outer cover layer such as cover layer 49 or to a touch-sensor layer such as touch-sensor (FIG. 2).

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

Backlight structures 42 may include a backlight light guide plate such as light guide plate 78. Light guide plate 78 may be formed from a transparent material such as clear glass or plastic. During operation of backlight structures 42, a light source such as light source 72 may generate light 74 that is injected into an edge of light guide plate 78. Light source 72 may be, for example, an array of light-emitting diodes.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

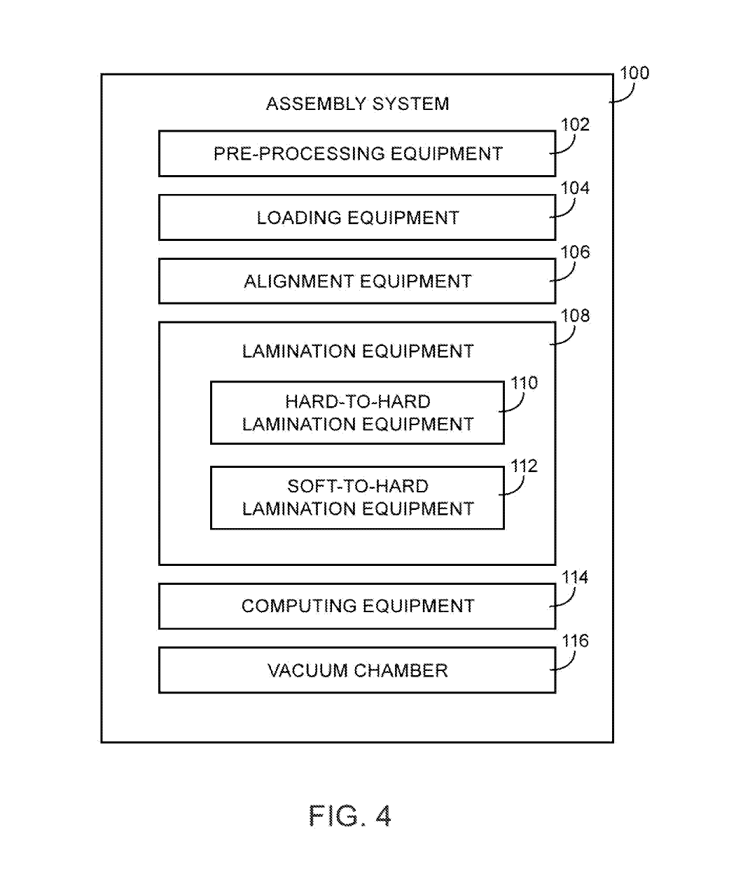

Backlight structures 42 may include optical films 70 such as diffuser layers for helping to homogenize backlight 44, compensation films for enhancing off-axis viewing, and brightness enhancement films (also sometimes referred to as turning films) for collimating backlight 44. FIG. 4 is a diagram of an illustrative assembly system that may be used for laminating together rigid structures or other substrates such as display layers for display 14. During assembly operations for display 14 of device 10, a manufacturing system such as assembly system 100 may be used to assemble image-generating layers 46, cover layer 49, touch sensor 47, and, if desired, backlight unit 42 to form display 14.

As shown in FIG. 4, assembly system 100 may include pre-processing equipment 102. Pre-processing equipment 102 may be used to clean a substrate prior to lamination, remove protective films from a substrate prior to lamination or otherwise pre-process one or more rigid or flexible substrates prior to lamination operations.

System 100 may include lamination equipment 108 such as hard-to-hard lamination equipment 110 and soft-to-hard lamination equipment 112. Hard-to-hard lamination equipment 110 may be used to laminate together two rigid structures such as image-generating layers 46 and sensor-on-glass assembly 30. Soft-to-hard lamination equipment 112 may be used to attach a soft substrate such as a sheet of optically clear light-curing adhesive onto a rigid substrate such as sensor-on-glass assembly 30. System 100 may include an evacuated portion such as vacuum chamber 116. Some or all of lamination equipment 108 may be formed within vacuum chamber 116 so that the risk of defects such as air bubbles may be further reduced during lamination operations.

System 100 may include other equipment such as loading equipment 104 and alignment equipment 106 for positioning substrates in lamination equipment 108. System 100 may also include computing equipment 114 for controlling lamination equipment 108, loading equipment 104, alignment equipment 106, and pre-processing equipment 102 during lamination operations.

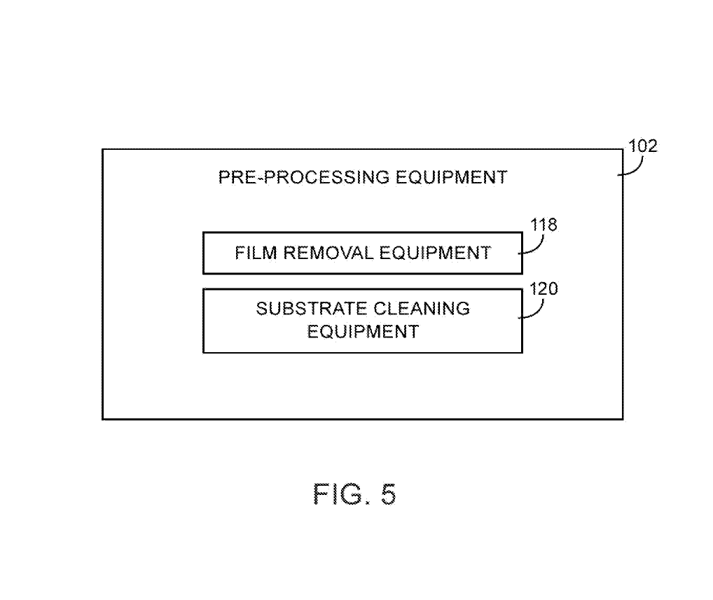

FIG. 5 is a diagram of pre-processing equipment of the type that may be used in a system such as system 100 of FIG. 4. As shown in FIG. 5, pre-processing equipment 102 may include film removal equipment 118 and substrate cleaning equipment 120. Film removal equipment 118 may include mechanical, robotic, manual, or automatic equipment for removing one or more protective films from substrates such as display substrates prior to assembly of the substrates into an assembled display. Protective films may be provided on display substrates such as touch-sensor substrates or liquid crystal display cells for transport to assembly facilities.

Following removal of any protective films, each substrate may be cleaned using substrate cleaning equipment 120. Substrate cleaning equipment may include one or more cleaning rollers such as pressure-sensing cleaning rollers. A substrate such as a display substrate may be passed between two or more pressure sensing cleaning rollers during cleaning operations to remove debris from the substrate prior to lamination of the substrate.

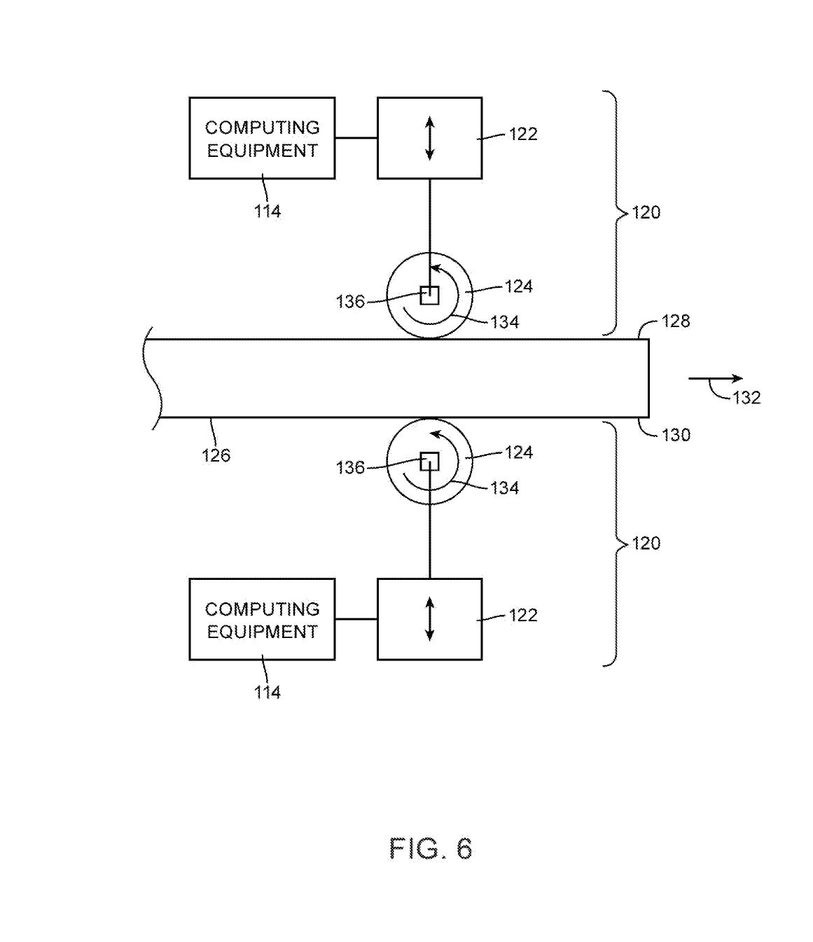

As shown in FIG. 6, cleaning equipment 120 may include computing equipment 114 coupled to computer-controlled positioning equipment 122. Computer-controlled positioning equipment 122 may be coupled to pressure-sensing cleaning rollers 124. Equipment 120 may include one or more cleaning rollers 124 that roll along each surface of a substrate such as substrate 126. In the example of FIG. 6, equipment 120 includes one roller that rolls along surface 130 of substrate 126 and one roller that rolls along an opposing surface such as surface 128 of substrate 126. Rollers 124 may rotate in directions 134 as substrate 126 passes between rollers 124.

Substrate 126 may be any suitable glass, polymer, silicon, or other substrate. As examples, substrate 126 may be touch sensor 47, cover layer 49, image-generating layers 46, backlight structures 42, a polymer or glass substrate associated with any of touch sensor 47, cover layer 49, image-generating layers 46, or backlight structures 42 or any other display substrate having sensitive electronics on or within the substrate.

Computer-controlled positioning equipment 122 may include one or more motors that turn rollers 124 in directions 134 to drive substrate 126 between rollers 124 or rollers 124 may turn in directions 134 in response to the motion of substrate 126 in direction 132. Each roller 124 may have a surface that is tacky so that debris such as dust on surfaces 128 or 130 adheres to one of rollers 124 as the roller rolls over that surface. Computer-controlled positioning equipment 122 may include one or more motors, levers, pistons such as hydraulic pistons, posts, platforms, or other equipment for moving, rotating, turning, sliding, tilting or otherwise positioning cleaning rollers 124.

In order to prevent damage to substrate 126 during cleaning operations, each roller 124 may include one or more corresponding pressure sensors 136. Pressure sensors 136 may be attached to an end of a roller 124, attached to a surface of roller 124, embedded within a roller 124, attached to actuating equipment for a roller 124, attached to a mounting structure for roller 124 or may be otherwise suitably positioned to sense the pressure with which a roller presses against a surface of substrate 126.

Pressure sensors 136 may include capacitive pressure sensors, piezoelectric pressure sensors, microelectromechanical systems (MEMS) based pressure sensors, pressure transducers, silicon-based pressure sensors, strain gauges, capacitive pressure sensors, optical pressure sensors, inductive pressure sensors or pressure sensors implemented using other suitable pressure sensing technology.

Pressures sensors 136 may be formed at discrete locations on a cleaning roller or may form a pressure sensing outer surface of a cleaning roller that extends around all or substantially all of the cleaning roller.

During cleaning operations, computing equipment 114 may receive pressure signals from pressure sensors 136 of rollers 124 (e.g., over a wired or wireless connection between sensors 136 and computing equipment 114). The pressure signals from sensors 136 may be proportional to the amount of pressure being applied to a surface (e.g., surface 128 or surface 130) of substrate 126 (e.g., at the position of the pressure sensor) while the roller is pressed against substrate 126.

Computing equipment 114 may convert the pressure signals in to pressure data and compare the pressure data with known target pressures for safe cleaning of substrate 126. The known target pressures may include absolute pressure ranges within which substrate 126 can be safely cleaned without damaging substrate 126 and/or relative pressures that indicate that pressure is being evenly (uniformly) applied across substrate 126 during cleaning operations.

Computing equipment 114 may instruct positioning equipment 122 to press rollers 124 against substrate 126 while rolling rollers 124 along surfaces of substrate 126 and while adjusting the position and orientation of rollers 124 based on the comparison of the pressure data from pressure sensors 136 with the known target pressures.

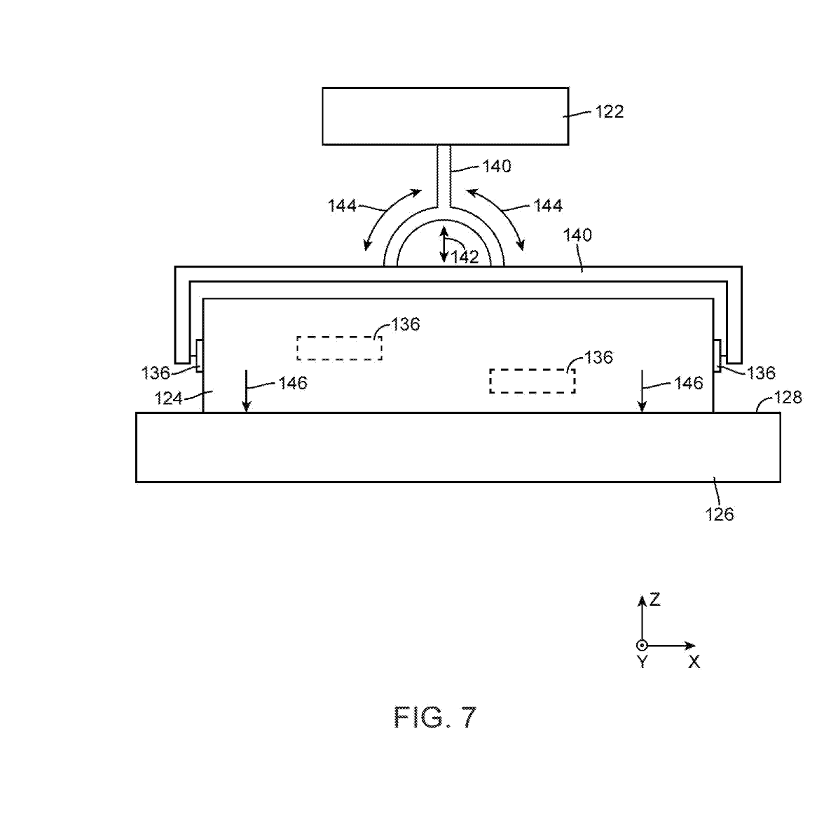

As shown in FIG. 7, computer-controlled positioning equipment 122 may be attached to a cleaning roller such as roller 124 using support structures such as structures 140 that are attached between roller 124 and positioning equipment 122. Signals from computing equipment 114 (see, e.g., FIG. 6) may instruct equipment 122 to move turn roller 124, to move roller 124 laterally (i.e., in the x-y plane of FIG. 7), vertically (i.e., in the positive or negative z-direction of FIG. 7 as indicated by arrows 142), or to rotate roller 124 (e.g., rotate roller 124 within the x-y plane or out of the x-y plane of FIG. 7 as indicated by arrows 144).

For example, in response to pressure signals from pressure sensors 136, computing equipment 114 may instruct equipment 121 to move roller 124 vertically up or down so that the pressure applied by roller 124 in direction 146 on surface 128 of substrate 126 does not exceed a maximum pressure. In this way, damage to substrate 126 by cleaning rollers 124 may be prevented.

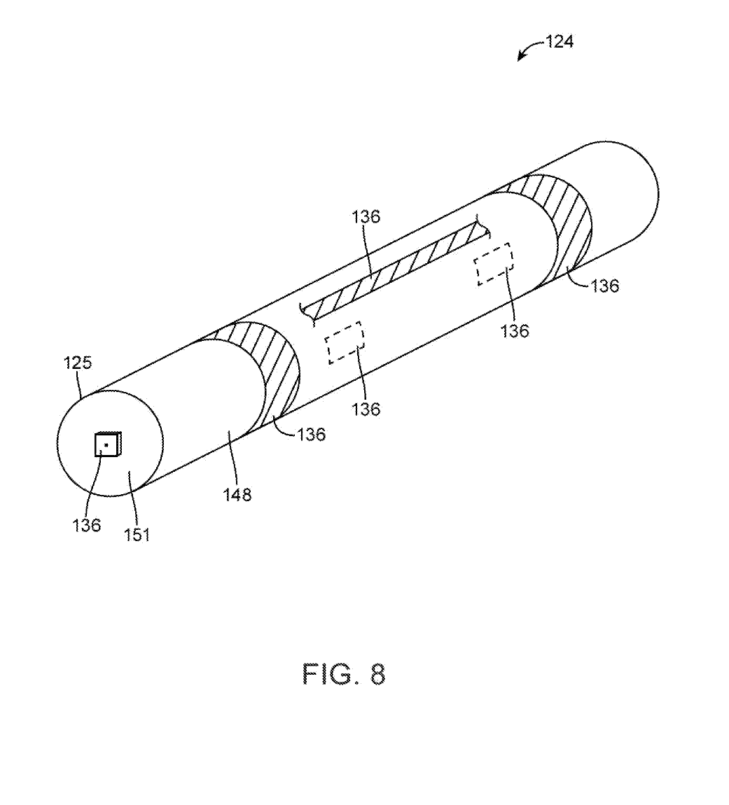

FIG. 8 is a perspective view of a pressure-sensing cleaning roller of the type that may be used in cleaning equipment 120 of system 100. As shown in FIG. 8, pressure sensors 136 may be formed on a roller member such as cylindrical roller member 125 of roller 124. Pressure sensors 136 may be formed on edge 151 of cylindrical roller member 125 of roller 124, may include one or more a pressure-sensitive strip circuits that wrap around a portion of roller 124 on surface 148 of cylindrical roller member 125 or that extend longitudinally along roller member 125 on surface 148, or may include embedded pressure sensors 136. However, this is merely illustrative. If desired, pressure sensors for cleaning rollers 124 may be mounted on support structures 140 (see FIG. 5) or on actuating portions of computer-controlled actuating equipment 122. Surface 148 may be a tacky (sticky) surface to which debris such as dust adheres when surface 148 is rolled against the surface of the substrate.

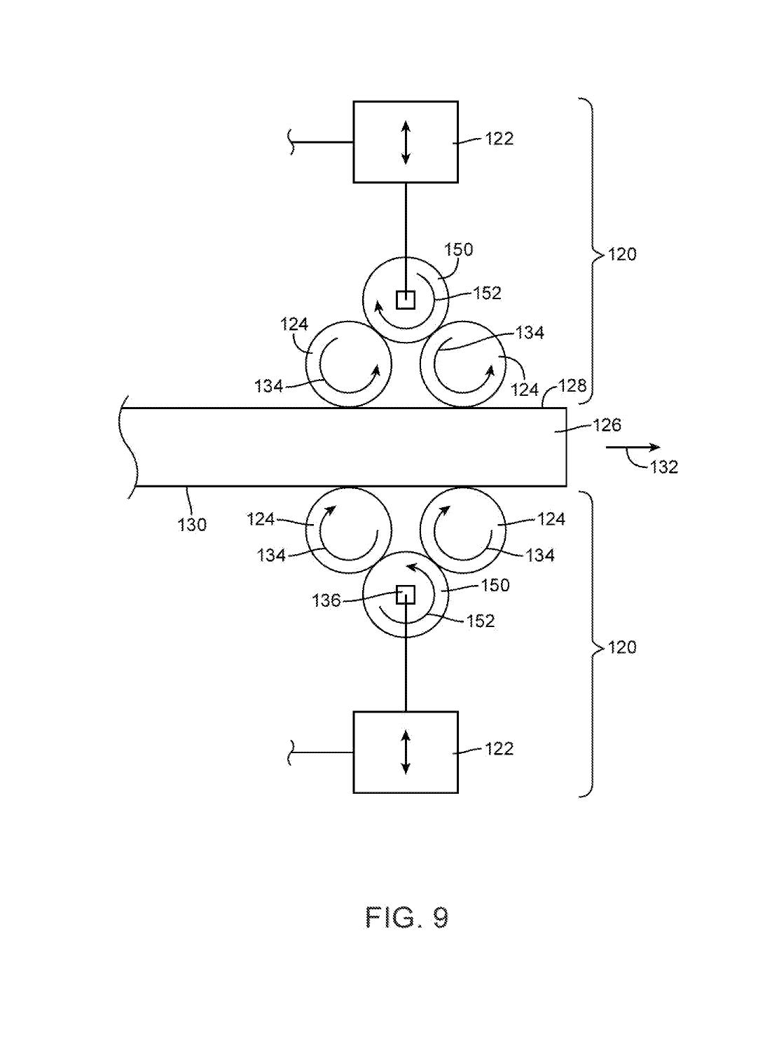

As shown in FIG. 9, equipment 120 may include more that one cleaning roller 124 that rolls along each surface 128 and 130 of substrate 126 and a transfer roller such as one of transfer rollers 150 associated with the cleaning rollers that roll along each surface.

In the example of FIG. 9, equipment 120 includes a transfer roller 150 on each side of substrate 126 that contacts two cleaning rollers 124 on that side of the substrate. Computer-controlled positioning equipment 122 may drive the rotation of transfer rollers 150 in direction 152 so that transfer rollers 150 roll against cleaning rollers 124, thereby driving the rotation of cleaning rollers 124 along substrate 126 and thereby moving substrate 126 in direction 132.

Transfer rollers 150 may each have a tacky surface that is in contact with the tacky surface of cleaning rollers 124. In this way, debris that is collected by cleaning rollers 124 is transferred to transfer rollers 150. If desired, transfer rollers 150 may include one or more pressure sensors 136 for sensing the pressure with which cleaning rollers 124 are pressed against surfaces 128 and/or 130.

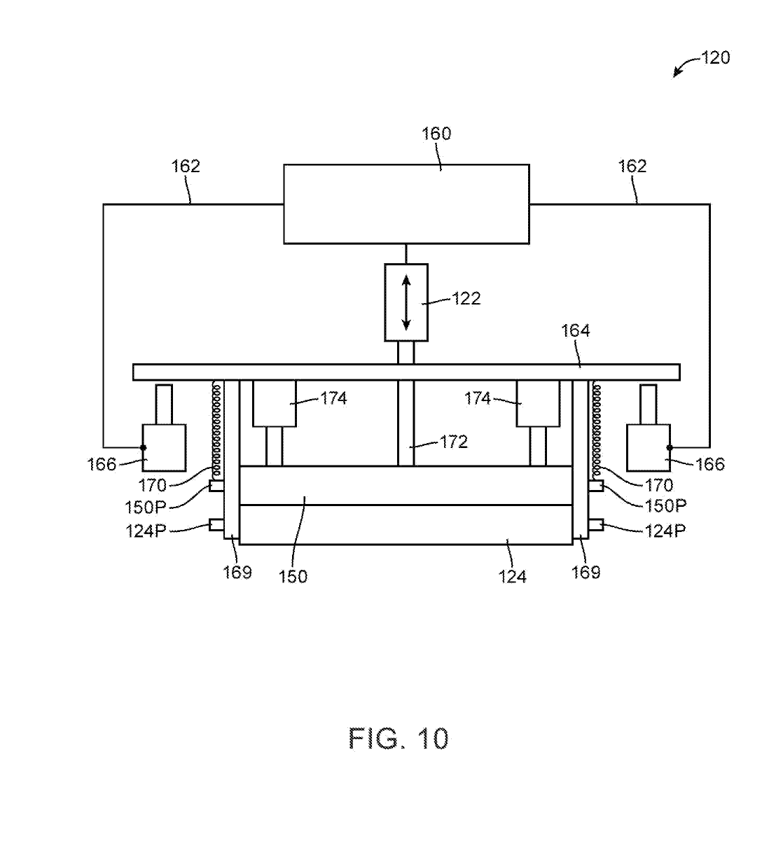

FIG. 10 is a side view of cleaning equipment 120 of the type shown in FIG. 9 showing how cleaning rollers 124 and transfer roller 150 may be mounted in a support structure formed from a horizontal support member such as member 164 and vertical support members 169 located on opposing edges of rollers 124 and 150. Rollers 124 and 150 may each include respective protruding edge portions 124P and 150P that extend through openings on vertical support members 169. Protruding portions 124P and 150P that extend through support member 169 may have a cylindrical shape that allows the protruding portions to rotate within the openings.

As shown in FIG. 10 protruding portions 150P may be coupled to elastic members such as spring members 170 that elastically attach portions 150P to horizontal support member 164. In this way, a roller package that includes rollers 150 and 124 may be pulled upwards towards support member 164.

In order to vertically position rollers 150 and 124, computer-controlled positioning equipment 122 may be coupled to actuating member 172 that pushes roller 150 (and thereby pushes rollers 124) downward away from member 164. In this way, elastic member 170 and actuating member 172, in combination, may be used to vertically position rollers 150 and rollers 124 with respect to a substrate to be cleaned.

In the example of FIG. 10, pressure sensors 136 have been implemented using electronic pressure regulators 174 and 166. Pressure regulators 174 and/or 166 may be coupled to computing equipment such as regulator computing equipment 160 over communications paths such as path 162.

Regulator computing equipment 160 may form a portion of computing equipment 114 of, for example, FIG. 6. Pressure regulators 174 may be configured to sense the pressure between horizontal support member 164 and roller 150. Pressure regulators 166 may be separated from horizontal member 164 so that, if one of regulators 166 contacts member 164, a signal is generated by equipment 160. The signal generated by equipment 160 may cause equipment 120 to shut down cleaning operations, to adjust the position of rollers 150 and 124, or to commence cleaning operations. Pressure signals may be generated by either of regulators 174 or 166 and used to control the position of rollers 124 and 150 with respect to a substrate to be cleaned during cleaning operations.

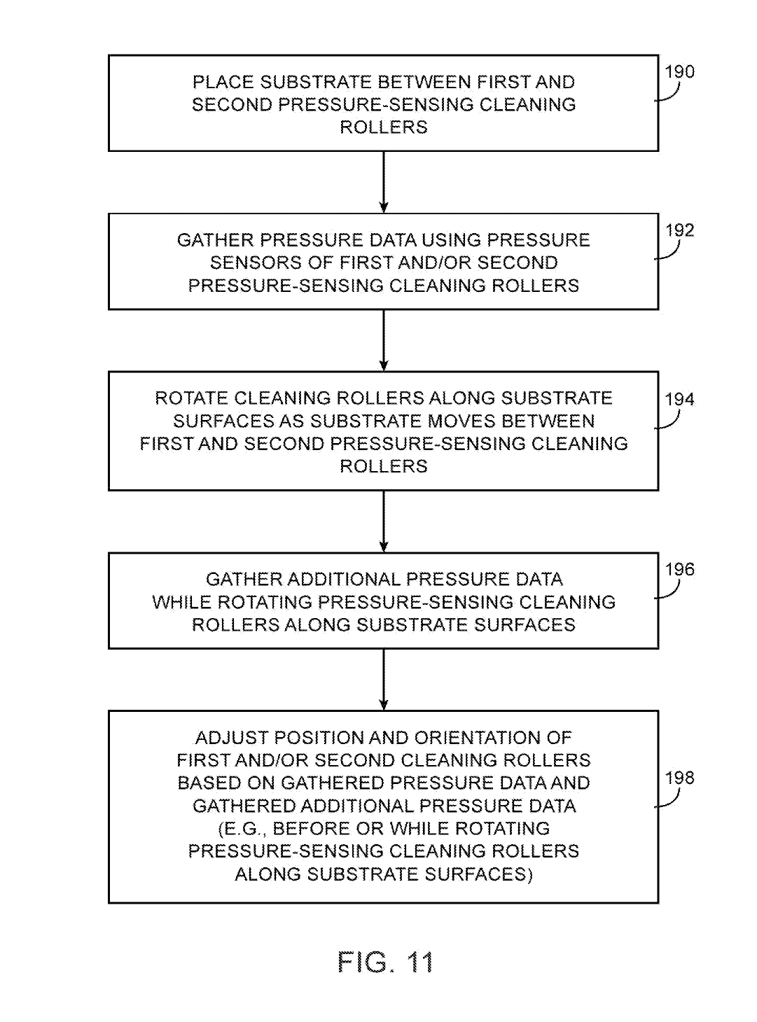

Illustrative steps that may be used to remove debris such as dust from a structure such as a semiconductor substrate or a display layer of an electronic device display using cleaning equipment having pressure-sensing cleaning rollers of the type shown in FIGS. 6, 7, 8, 9, and/or 10 are shown in FIG. 11.

At step 190, a substrate such as a display layer for an electronic device display may be placed between at least first and second pressure-sensing cleaning rollers. If desired, the substrate may be placed between multiple pressure-sensing cleaning rollers on each side of the substrate.

At step 192, computing equipment such as computing equipment 114 (see, e.g., FIG. 6) may gather pressure data using pressure sensors of the first and/or second cleaning rollers (e.g., pressure sensors located on, embedded within, or attached to equipment or structures associated with one or more of the pressure-sensing cleaning rollers). If desired, the positions and orientations of the cleaning rollers may be modified based on the pressure data.

At step 194, the pressure-sensing cleaning rollers may be rotated (rolled) along one or more surfaces of the substrate as the substrate moves between the first and second pressure-sensing cleaning rollers. The rotating rollers may be used to drive the substrate through the space between the rollers or other equipment may be used to push the substrate through the space between the rollers.

At step 196, additional pressure data may be gathered using the pressure sensors while rotating the pressure-sensing cleaning rollers along the substrate surfaces.

At step 198, computer-controlled positioning equipment may be used to adjust the position and orientation of the first and/or the second cleaning rollers (or sets of cleaning rollers) based on the gathered pressure data and the gathered additional pressure data. The position and orientation of the pressure-sensing cleaning rollers may be adjusted before and/or while rotating the pressure-sensing cleaning rollers are rotated (rolled) along the surfaces of the substrate.

In accordance with an embodiment, an assembly system for electronic device displays is provided that includes a cleaning roller for removing debris from a surface of a substrate, a pressure sensor coupled to the first cleaning roller, computing equipment that receives pressure signals from the pressure sensor, and computer controlled positioning equipment coupled to the cleaning roller, where the computing equipment is configured to instruct the computer controlled positioning equipment to move the cleaning roller based on the received pressure data.

In accordance with another embodiment, the pressure sensor is attached to the cleaning roller.

In accordance with another embodiment, the assembly system further includes an additional cleaning roller for removing additional debris from an opposing surface of the substrate.

In accordance with another embodiment, the assembly system further includes an additional pressure sensor coupled to the additional cleaning roller.

In accordance with another embodiment, the assembly system further includes a transfer roller mounted in contact with the cleaning roller.

In accordance with another embodiment, the assembly system further includes an additional transfer roller mounted in contact with the additional cleaning roller.

In accordance with another embodiment, the assembly system further includes a horizontal support member and first and second vertical support members attached to the horizontal support member, where the cleaning roller and the transfer roller are each mounted to the first and second vertical support members.

In accordance with another embodiment, the transfer roller includes protruding edge members that extend through openings in the first and second vertical support members and the assembly system further includes at least one elastic member coupled between the protruding edge members and the horizontal support member.

In accordance with another embodiment, the pressure sensor is interposed between the transfer roller and the horizontal support member.

In accordance with an embodiment, a pressure-sensing cleaning roller for removing debris from a surface of a substrate is provided that includes a cylindrical roller member having a tacky surface that collects the debris from the surface of the substrate when the tacky surface is rolled against the surface of the substrate and at least one pressure sensor coupled to the cylindrical roller member, where the at least one pressure sensor is configured to generate pressure signals in response to contact between the tacky surface and the surface of the substrate.

In accordance with another embodiment, the substrate includes at least one layer of an electronic device display.

In accordance with another embodiment, the electronic device display includes a liquid crystal display.

In accordance with another embodiment, the at least one layer of the electronic device display includes a touch-sensitive layer.

In accordance with another embodiment, the at least one pressure sensor is attached to an edge of the cylindrical roller member.

In accordance with another embodiment, the at least one pressure sensor is attached to the tacky surface of the cylindrical roller member.

In accordance with another embodiment, the at least one pressure sensor is embedded within the cylindrical roller member.

In accordance with an embodiment, a method is provided of cleaning a substrate using substrate cleaning equipment that includes first and second pressure-sensing cleaning rollers, at least one pressure sensor, and computer-controlled positioning equipment for the first and second pressure-sensing cleaning rollers, the method including placing the substrate between the first and second pressure-sensing cleaning rollers, gathering pressure data using the at least one pressure sensor, adjusting a position of the first pressure-sensing cleaning roller based on the gathered pressure data, and rolling the first and second pressure-sensing cleaning rollers along respective first and second surfaces of the substrate.

In accordance with another embodiment, the method further includes adjusting a position of the second pressure-sensing cleaning roller based on the gathered pressure data.

In accordance with another embodiment, adjusting the position of the first pressure-sensing cleaning roller based on the gathered pressure data includes adjusting the position of the first pressure-sensing cleaning roller while rolling the first and second pressure-sensing cleaning rollers along the respective first and second surfaces of the substrate.

In accordance with another embodiment, adjusting the position of the first pressure-sensing cleaning roller based on the gathered pressure data includes adjusting the position of the first pressure-sensing cleaning roller before rolling the first and second pressure-sensing cleaning rollers along the respective first and second surfaces of the substrate.

In accordance with another embodiment, the substrate cleaning equipment further includes a transfer roller mounted in contact with the first pressure-sensing cleaning roller, the method further including rolling the transfer roller against a surface of the first pressure-sensing cleaning roller to remove debris from the first pressure-sensing cleaning roller.

In accordance with another embodiment, the method further includes determining a pressure with which the first pressure-sensing cleaning roller presses against the first surface of the substrate based on the gathered pressure data and determining whether the determined pressure exceeds a maximum pressure.

The foregoing is merely illustrative of the principles of this invention and various modifications can be made by those skilled in the art without departing from the scope and spirit of the invention.

What is claimed is:

1. An assembly system for electronic device displays comprising:
a cleaning roller for removing debris from a surface of a substrate;
a pressure sensor coupled to the cleaning roller;
computing equipment that receives pressure signals from the pressure sensor; and
computer controlled positioning equipment coupled to the cleaning roller, wherein the computing equipment is configured to instruct the computer controlled positioning equipment to move the cleaning roller based on the received pressure data.

2. The assembly system defined in claim 1 wherein the pressure sensor is attached to the cleaning roller.

3. The assembly system defined in claim 1, further comprising an additional cleaning roller for removing additional debris from an opposing surface of the substrate.

4. The assembly system defined in claim 3, further comprising an additional pressure sensor coupled to the additional cleaning roller.

5. The assembly system defined in claim 4, further comprising a transfer roller mounted in contact with the cleaning roller.

6. The assembly system defined in claim 5, further comprising an additional transfer roller mounted in contact with the additional cleaning roller.

7. The assembly system defined in claim 6, further comprising a horizontal support member and first and second vertical support members attached to the horizontal support member, wherein the cleaning roller and the transfer roller are each mounted to the first and second vertical support members.

8. The assembly system defined in claim 7 wherein the transfer roller includes protruding edge members that extend through openings in the first and second vertical support members and wherein the assembly system further comprises at least one elastic member coupled between the protruding edge members and the horizontal support member.

9. The assembly system defined in claim 8 wherein the pressure sensor is interposed between the transfer roller and the horizontal support member.

10. A pressure-sensing cleaning roller for removing debris from a surface of a substrate, comprising:
a cylindrical roller member having a tacky surface that collects the debris from the surface of the substrate when the tacky surface is rolled against the surface of the substrate; and
at least one pressure sensor coupled to the cylindrical roller member, wherein the at least one pressure sensor is configured to generate pressure signals in response to contact between the tacky surface and the surface of the substrate.

11. The pressure-sensing cleaning roller defined in claim 10 wherein the substrate comprises at least one layer of an electronic device display.

12. The pressure-sensing cleaning roller defined in claim 11 wherein the electronic device display comprises a liquid crystal display.

13. The pressure-sensing cleaning roller defined in claim 11 wherein the at least one layer of the electronic device display comprises a touch-sensitive layer.

14. The pressure-sensing cleaning roller defined in claim 10 wherein the at least one pressure sensor is attached to an edge of the cylindrical roller member.

15. The pressure-sensing cleaning roller defined in claim 10 wherein the at least one pressure sensor is attached to the tacky surface of the cylindrical roller member.

16. The pressure-sensing cleaning roller defined in claim 10 wherein the at least one pressure sensor is embedded within the cylindrical roller member.

17. A method of cleaning a substrate using substrate cleaning equipment that includes first and second pressure-sensing cleaning rollers, at least one pressure sensor, and computer-controlled positioning equipment for the first and second pressure-sensing cleaning rollers, the method comprising:
placing the substrate between the first and second pressure-sensing cleaning rollers;
gathering pressure data using the at least one pressure sensor;
adjusting a position of the first pressure-sensing cleaning roller based on the gathered pressure data; and
rolling the first and second pressure-sensing cleaning rollers along respective first and second surfaces of the substrate.

18. The method defined in claim 17, further comprising adjusting a position of the second pressure-sensing cleaning roller based on the gathered pressure data.

19. The method defined in claim 17 wherein adjusting the position of the first pressure-sensing cleaning roller based on the gathered pressure data comprises adjusting the position of the first pressure-sensing cleaning roller while rolling the first and second pressure-sensing cleaning rollers along the respective first and second surfaces of the substrate.

20. The method defined in claim 17 wherein adjusting the position of the first pressure-sensing cleaning roller based on the gathered pressure data comprises adjusting the position of the first pressure-sensing cleaning roller before rolling the first and second pressure-sensing cleaning rollers along the respective first and second surfaces of the substrate.

21. The method defined in claim 17 wherein the substrate cleaning equipment further comprises a transfer roller mounted in contact with the first pressure-sensing cleaning roller, the method further comprising rolling the transfer roller against a surface of the first pressure-sensing cleaning roller to remove debris from the first pressure-sensing cleaning roller.

22. The method defined in claim 17, further comprising:
determining a pressure with which the first pressure-sensing cleaning roller presses against the first surface of the substrate based on the gathered pressure data; and
determining whether the determined pressure exceeds a maximum pressure.
